(19) United States
(12) Patent Application Publication
(10) Pub. No.: US 2026/0036501 A1
(43) Pub. Date: Feb. 5, 2026

(54) DEVICE AND METHOD FOR DETECTING RUPTURE BEHAVIOR OF A BATTERY CELL

(71) Applicant: PowerCo SE, Salzgitter (DE)

(72) Inventors: Fabian KLINGEBIEL, Braunschweig (DE); Jan TEUWSEN, Braunschweig (DE)

(21) Appl. No.: 19/290,608

(22) Filed: Aug. 5, 2025

(30) Foreign Application Priority Data
Aug. 5, 2024 (DE) 10 2024 207 379.2

(51) Int. Cl. G01N 3/08; G01N 3/06; H01M 10/42

(52) U.S. Cl. CPC G01N 3/08; G01N 3/066; G01N 3/068; H01M 10/4228; H01M 10/4285; G01N 2203/0067

(57) ABSTRACT

A device for detecting rupture behavior of a battery cell. The device includes an indenter and a number of sensors. The indenter contains a contact surface that is configured to deform the battery cell in a contact region until rupture. The number of sensors is configured to detect the rupture behavior of the battery cell in the contact region.

### CROSS-REFERENCE TO RELATED APPLICATION

This application claims the priority, under 35 U.S.C. § 119, of German Patent Application DE 10 2024 207 379.2, filed Aug. 5, 2024; the prior application is herewith incorporated by reference in its entirety.

### FIELD AND BACKGROUND OF THE INVENTION

The proposed invention relates to a device and a method for detecting rupture behavior of a battery cell, in accordance with the appended claims.

In battery cell deformation tests, such as so-called “crush tests” or “crash tests”, for example, a rupture disk or a so-called “vent” of a battery cell is deformed by a penetrating body, a so-called “indenter”. The vent, which actually functions as a predetermined breaking point for regulating the internal pressure, is damaged by deformation by the indenter from the outside until failure or bursting, such that electrolyte escapes from the battery cell.

In a crush test, in which a vent is pressed in by a for example spherical indenter made of steel, the indenter obscures the view of the vent, and therefore it cannot be seen clearly at which point in time of the crush test, in particular at which intrusion depth and with which force and at which position the battery cell explodes or bursts. However, this information is critically important for optimizing battery cell design or for creating a cell design for this load situation.

Methods are known in which blotting paper is laid out around an indenter, so as to obtain a visual evaluation of the rupture behavior of a battery cell.

Furthermore, U.S. patent publication No. 2012/0133521 A1 describes a battery arrangement having a fault identification mechanism for identifying and reporting faults in the battery arrangement.

U.S. patent publication No. 2024/0021888 A1 describes a battery module that contains a module for identifying an electrolyte leakage.

Chinese patent application CN 116481728 A1 describes a device for identifying an electrolyte leakage in a battery cell.

Under the proposed invention, a device and a method for detecting rupture behavior of a battery cell are proposed. Further features and details of the invention can be gathered from the respective dependent claims, the description and the drawings. Features and details that are described in connection with the method according to the invention are, of course, also applicable in connection with the device according to the invention and vice versa, and therefore, with respect to the disclosure, reference is or can always be made alternately to the individual aspects of the invention.

### SUMMARY OF THE INVENTION

Against this background, it is an object of the proposed invention to provide a possibility for detecting rupture behavior of a battery cell.

Therefore, according to a first aspect of the proposed invention, a device for detecting rupture behavior of a battery cell is proposed.

The proposed device contains an indenter and a number of sensors, wherein the indenter contains a contact surface that is configured to deform the battery cell in a contact region until rupture, wherein the number of sensors is configured to detect the rupture behavior of the battery cell in the contact region.

In the context of the proposed invention, an indenter is understood to be an object that is configured to deform a battery cell, in particular to apply a predefined force thereto in a predefined contact region between the indenter and the battery cell, which force flows through the battery cell in accordance with a predefined force flow.

An indenter is used, in particular, to destroy a rupture disk of the battery cell, so that electrolyte is discharged from the battery cell. For this purpose, the indentor contains a contact surface that is round, for example, and through which the force is coupled into the battery cell.

The proposed device is based on a number of sensors, such as cameras or electric modules, for example, which is configured to capture a contact region in which a contact surface of the indenter provided according to the invention comes into contact with a respective battery cell, and processes taking place there, in particular discharge of electrolyte from the battery cell. Accordingly, the sensors provided according to the invention capture a region that is obscured by the indenter during a deformation process of the battery cell and thus cannot be seen visually or by an observer.

On the basis of sensor data determined by the number of sensors, behavior of the battery cell, in particular in the contact region, i.e. for example deformation behavior of a vent of the battery cell, can be observed, in particular measured and evaluated.

It can be provided that the number of sensors contains a number of cameras that is configured to capture the contact region through the contact surface.

Cameras are particularly advantageously suitable for detecting a change in the battery cell over time. To capture or scan the contact region, respective cameras can film through the contact region.

Accordingly, it can be provided that the contact surface is composed of a metal and a number of channels is formed in the contact surface, which channels connect a first region in front of the contact surface to a second region behind the contact surface in a light-conducting manner, and the number of cameras is configured to capture the contact region through the number of channels.

Channels that extend through the contact surface allow optical access for a number of cameras to the contact region, which cameras are arranged behind the contact surface and accordingly are mechanically protected by the contact surface, during a deformation process or while the contact surface is introduced into the contact region. Accordingly, a region in front of the indenter can be captured through the channels.

Furthermore, channels of this type make it possible to use cameras to capture the contact region in combination with a metal and accordingly opaque contact region, such that a corresponding indenter is particularly robust and reusable.

It can furthermore be provided that the contact surface is transparent at least in regions.

A contact surface that is transparent at least in regions makes it possible to comprehensively protect respective cameras arranged behind the contact surface and allows particularly good optical access for the cameras to the contact region.

A transparent contact region can be composed of a synthetic material, for example, in particular Plexiglas®. For example, a transparent contact region can be formed in a channel of a metal contact region.

Furthermore, it can be provided that the number of cameras contains a stereo camera and/or a thermal imaging camera.

A stereo camera allows for a particularly good spatial evaluation or a distance by which the contact region deforms, while a thermal imaging camera detects a thermal flow in the contact region.

It can furthermore be provided that the number of sensors contains a number of electric sensor modules, wherein each electric sensor module contains a voltage source and two conductors and the device furthermore contains at least one evaluation unit. Each conductor of the two conductors is connected to an electrical pole of the voltage source. The two conductors protrude through the contact surface spaced apart from one another, and the evaluation unit is configured to detect an electrical current flowing between the two conductors.

By means of electric modules, an electrical change in the contact region, in particular a discharge of electrolyte from the battery cell, can be detected. For this purpose, the two conductors lie on the contact surface of the indenter spaced apart from one another, such that the two conductors are electrically insulated from one another, for example by air. Accordingly, a discharge of electrolyte from the battery cell into an intermediate space between the two conductors brings about an electrical coupling of the two conductors, which produces an electrical circuit that can be measured by the evaluation unit.

Furthermore, it can be provided that the two conductors are connected via a dielectric layer. The electrical resistance of the dielectric layer in a first state, in which the dielectric layer is not in contact with electrolyte, differs from an electrical resistance of the dielectric layer in a second state, in which the dielectric layer is in contact with electrolyte.

By using a dielectric layer, even small amounts of electrolyte can lead to the closing of an electrical circuit between the two conductors of a respective electric module, and therefore even a small discharge of electrolyte can be detected by the electric module.

It can furthermore be provided that the device contains an actuator that is configured to press the contact surface against a battery cell.

An actuator, such as a motor for example, in particular an electric stepper motor or an electromagnet, provides a force in order to move the indenter and accordingly to deform the battery cell.

It can furthermore be provided that the device contains a computing unit that is configured to store sensor data determined by the number of sensors and/or to output said sensor data to an output unit.

In the context of the proposed invention, a computing unit is understood to be a computer, a processor, a control device or any other programmable circuit.

A computing unit can store respective sensor data and output them to an output unit, such as a display for example, in particular the data can be depicted in a diagram or a series of diagrams.

According to a second aspect, the proposed invention relates to a method for detecting rupture behavior of a battery cell.

The proposed method contains the provision of a possible configuration of the proposed device and the pressing of the indenter onto the battery cell until the battery cell ruptures.

In particular, a battery cell deformation test can be carried out by the proposed method.

Other features which are considered as characteristic for the invention are set forth in the appended claims.

Although the invention is illustrated and described herein as embodied in a device and a method for detecting rupture behavior of a battery cell, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is an illustration of a first possible configuration of a proposed device;

FIG. 2 is an illustration of a second possible configuration of the proposed device;

FIG. 3 is an illustration of a third possible configuration of the proposed device;

FIG. 4 is a detailed depiction of a sensor of the device according to FIG. 3; and

FIG. 5 is a flow chart describing a proposed method.

### DETAILED DESCRIPTION OF THE INVENTION

Referring now to the figures of the drawings in detail and first, particularly to FIG. 1 thereof, there is shown a device 100 for detecting rupture behavior of a battery cell 101 of a battery cell arrangement 110.

The device 100 comprises an indenter 103 and sensors 105, which are configured as cameras here by way of example.

The indenter 103 contains a contact surface 107 that is configured to deform the battery cell 101 in a contact region 109 until rupture.

The sensors 105 are configured to detect the rupture behavior of the battery cell 101 in the contact region 109. For this purpose, the contact surface 107 is configured to be transparent in the present case, by way of example, and is manufactured from a synthetic material, for example.

The device 100 further contains a computing unit 102 that is configured to store sensor data determined by the number of sensors 105 and/or to output the sensor data to an output unit 106.

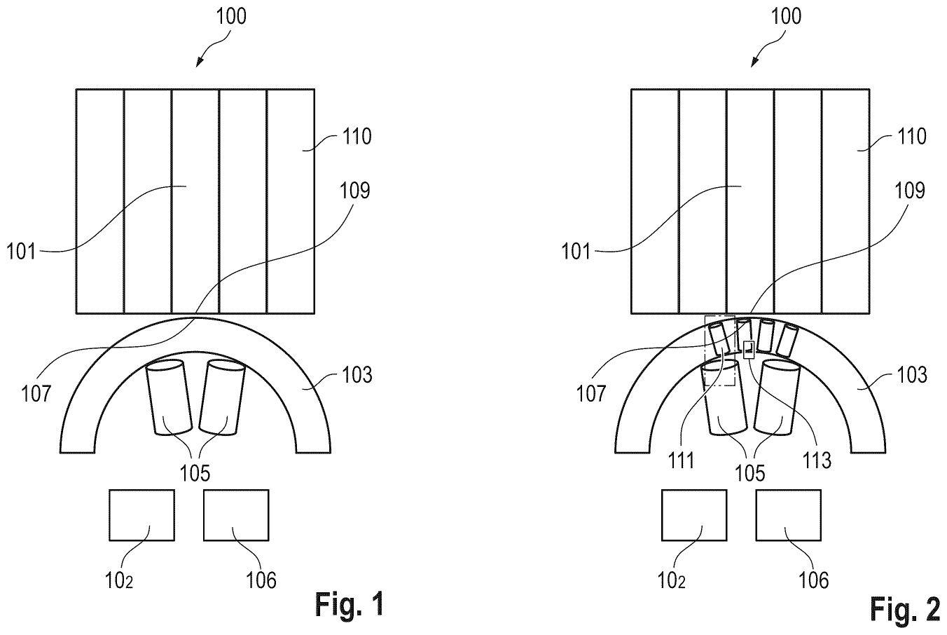

In FIG. 2, the contact surface 107 is manufactured from a metal, such as steel for example, and accordingly is opaque. To be able to capture the contact region 109 by means of the sensors 105, channels 111 are introduced into the contact surface 107, through which channels 111 the sensors 105 can film or sense. Illumination sources 113 are optionally provided, in order to light up the channels 111 and illuminate the contact region 109.

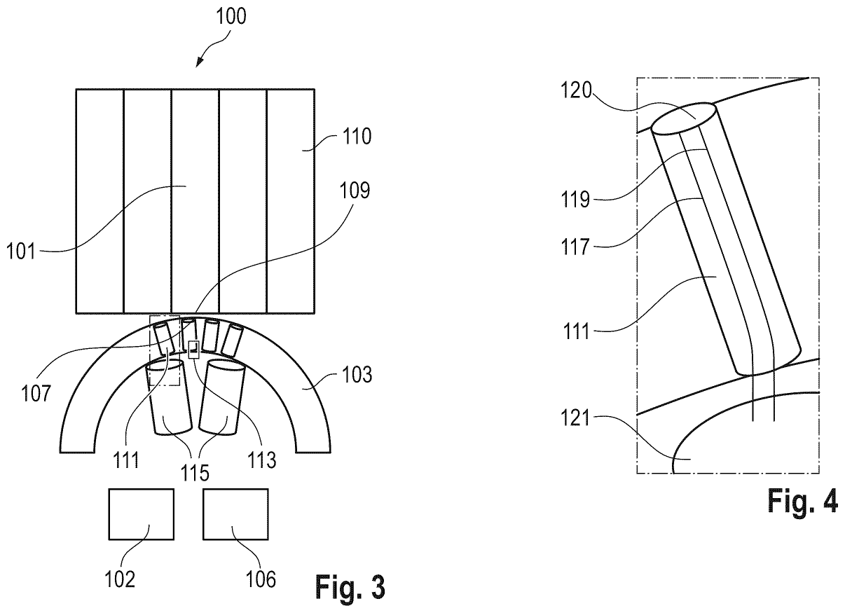

In FIG. 3, the sensors 105 are configured as electric sensor modules 115 that each comprise a voltage source 121 and two electrical conductors 117, 119.

The electrical conductors 117, 119 are in a channel 111 spaced apart from one another, as depicted in detail in FIG. 4, and protrude through the contact surface 107, such that an electrolyte that is discharged from the battery cell 101 and electrically couples the two electrical conductors 117, 119 closes an electrical circuit between the two conductors 117, 119. Accordingly, a current can be measured at the electrical circuit, which current behaves relatively in relation to the outflow of electrolyte from the battery cell 101.

Furthermore, it can be provided that the two conductors 117, 119 are optionally connected via a dielectric layer 120. The electrical resistance of the dielectric layer 120 in a first state, in which the dielectric layer 120 is not in contact with electrolyte, differs from an electrical resistance of the dielectric layer 120 in a second state, in which the dielectric layer 120 is in contact with electrolyte.

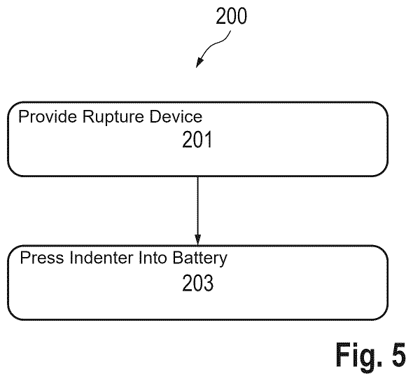

A method 200 for detecting rupture behavior of a battery cell 101 is depicted in FIG. 5.

The method 200 includes a provision step 201 in which the device 100 according to one of FIGS. 1 to 3 is provided, and a rupture step 203 in which the indenter 103 is pressed onto the battery cell 101 until the battery cell 101 ruptures.

The following is a summary list of reference numerals and the corresponding structure used in the above description of the invention:
100 device
101 battery cell
102 computing unit
103 indenter
105 sensor
106 output unit
107 contact surface
109 contact region
110 battery cell arrangement
111 channel
113 illumination source
115 sensor module
117 conductor
119 conductor
120 dielectric layer
121 voltage source
200 method
201 provision step
203 rupture step

1. A device for detecting rupture behavior of a battery cell, the device comprising:
an indenter having a contact surface configured to deform the battery cell in a contact region until rupture; and
a plurality of sensors configured to detect the rupture behavior of the battery cell in the contact region.

2. The device according to claim 1, wherein said plurality of sensors contains a plurality of cameras configured to capture the contact region through said contact surface.

3. The device according to claim 2, wherein:
said contact surface is composed of a metal and said plurality of channels is formed in said contact surface, said plurality of channels connect a first region in front of said contact surface to a second region behind said contact surface in a light-conducting manner; and
said plurality of cameras is configured to capture the contact region through said plurality of channels.

4. The device according to claim 2, wherein said contact surface is transparent at least in regions.

5. The device according to claim 1, wherein said plurality of cameras contains a stereo camera and/or a thermal imaging camera.

6. The device according to claim 1,
wherein said plurality of sensors has a plurality of electric sensor modules, each of said electric sensor modules contains a voltage source and two conductors;
further comprising at least one evaluation unit;
wherein each conductor of said two conductors is connected to an electrical pole of said voltage source;
wherein said two conductors protrude through said contact surface spaced apart from one another; and
wherein said at least one evaluation unit is configured to detect an electrical current flowing between said two conductors.

7. The device according to claim 6, wherein each of said electric sensor modules has a dielectric layer, said two conductors are connected via said dielectric layer, wherein an electrical resistance of said dielectric layer in a first state, in which said dielectric layer is not in contact with an electrolyte, differs from an electrical resistance of said dielectric layer in a second state, in which said dielectric layer is in contact with said electrolyte.

8. The device according to claim 6, further comprising an actuator configured to press said contact surface against the battery cell.

9. The device according to claim 1, further comprising:
an output unit; and
a computing unit configured to store sensor data determined by said plurality of sensors and/or to output the sensor data to said output unit.

10. A method for detecting rupture behavior of a battery cell, which comprises the steps of:
providing the device according to claim 1; and
pressing the indenter onto the battery cell until the battery cell ruptures.
